(19) United States
(12) Patent Application Publication
(10) Pub. No.: US 2026/0239369 A1
(43) Pub. Date: Aug. 13, 2026

(54) SYSTEMS AND METHODS FOR POWER SAVING

(71) Applicant: ZTE CORPORATION, Shenzhen (CN)

(72) Inventors: Youjun HU, Shenzhen (CN); Bo DAI, Shenzhen (CN); Mengzhu CHEN, Shenzhen (CN); Weiwei YANG, Shenzhen (CN); Kun LIU, Shenzhen (CN); Jun XU, Shenzhen (CN); Luanjian BIAN, Shenzhen (CN)

(21) Appl. No.: 19/156,653

(22) PCT Filed: Feb. 17, 2023
(86) PCT No.: PCT/CN2023/076826

§ 371 Date: Aug. 14, 2025

(51) Int. Cl. H04W 72/231; H04L 1/00; H04L 5/00; H04W 72/0446; H04W 76/20

(52) U.S. Cl. CPC H04W 72/231; H04L 1/0061; H04L 5/0012; H04W 72/0446; H04W 76/20

(57) ABSTRACT

Presented are systems and methods for power saving. A wireless communication device may receive a signal from a wireless communication node. The wireless communication device may determine a behavior according to the signal.

### CROSS-REFERENCE TO RELATED APPLICATION

This application is a national stage filing under 35 U.S.C. § 371 of international application number PCT/CN2023/076826, filed Feb. 17, 2023, the contents of which are incorporated herein by reference in its entirety.

### TECHNICAL FIELD

The disclosure relates generally to wireless communications, including but not limited to systems and methods for power saving in a communication system.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A wireless communication device (e.g., a UE) may receive a signal (e.g., a low power signal, a wake up signal (WUS), a low power wake up signal) from a wireless communication node (e.g., a BS). The wireless communication device may determine a behavior according to the signal. The signal may comprise first information. The first information may comprise at least one of: wake-up information; user equipment (UE) or wireless communication device identifier (ID) information; a defined ID information; UE or wireless communication device group information; a defined group ID information; cyclic redundancy check (CRC) information; radio network temporary identifier (RNTI) information; time duration or offset information; scrambling information; physical downlink control channel (PDCCH) related information; repetition information; frequency hopping information; discontinuous reception (DRX) related information; channel state information reference signal (CSI-RS) related information; tracking reference signal (TRS) availability information; search space (SS) group switching information; PDCCH skipping information; transmit power control (TPC) command information; sounding reference signal (SRS) request information; pre-emption indication information; channel occupancy time (COT) duration indicator information; available resource block (RB) set indicator information; secondary cell (SCell) dormancy indication information; or information based on any of foregoing information.

In some embodiments, a low-power wake-up signal (LP-WUS) may trigger a UE behavior for power saving. The wake-up information can be timing information for the wake-up (e.g., time length/offset/duration before the wake-up is to occur). A physical downlink control channel (PDCCH) related information may comprise a predefined, signaled, or indicated PDCCH occasion. The information based on any of foregoing information comprise at least one of: information combination of the first information, a UE ID based information, or part of UE ID information. A time duration/offset information may comprise at least one of: a time duration/offset between the signal and a PDCCH occasion; a time duration/offset between the signal and a PRACH occasion; or a time duration/offset between the signal and a paging occasion.

In some embodiments, the signal may comprise at least one of: a preamble portion; or a payload portion. The preamble portion may comprise at least one preamble. The payload portion may comprise at least 1 bit. The preamble portion and the payload portion may comprise: the preamble portion, followed by an offset, and followed by the payload portion. The offset can be a time duration/gap (e.g., 0, 10, or 20) based on subcarriers, symbols, slots, us, ms, or any time units. The offset may comprise: a frequency offset between the preamble portion and the payload portion; or a time offset between the preamble portion and the payload portion. The payload may include a cyclic redundancy check (CRC), or not include CRC. The payload portion and a data portion can be similar. The preamble portion and the payload portion may comprise: a first preamble portion, followed by the payload portion, and followed by a second preamble portion.

In some embodiments, the first preamble portion, the payload portion and the second preamble portion can be continuous in time domain. A first time offset (e.g., a gap, a duration, a period, or an interval) between the first preamble portion and the payload portion, can be same as a second time offset between the second preamble portion and the payload portion. The first time offset and the second time offset can be predefined, or signaled to the wireless communication device, or indicated to the wireless communication device via downlink control information (DCI) signaling. The preamble portion may comprise or indicate at least one of: the first information, or information based on the first information; size of the payload portion; format of the payload portion or format of the signal; position (e.g., starting position or ending position) of the payload portion; a time or frequency offset between the preamble portion and the payload portion; presence of specific information in the payload portion; presence of a specific indicator, bit or field in the payload portion; frequency hopping for the payload portion; repetition for the payload portion; cell identifier (ID) based information (e.g., part of cell ID, whole cell ID, tracking area, or RAN area); or UE related information.

In some embodiments, the preamble portion and the payload portion can be continuous in time domain or frequency domain. The frequency offset or the time offset can be predefined, or signaled to the wireless communication device, or indicated to the wireless communication device via downlink control information (DCI) signaling. The signaling may include a radio resource control (RRC) signaling, a medium access control control element (MAC CE) signaling, or a system information block (SIB) signaling. In some embodiments, a UE may inspect/detect the preamble portion through a blind detection of candidate signal.

In some embodiments, the signal may include one of a plurality of formats. The plurality of formats may comprise at least one of: a format based on multiple preambles; a format based on the preamble portion; a format based on the preamble portion, and the payload portion; a format based on the preamble portion, and the payload portion with a fixed size; a format based on the preamble portion, and the payload portion with a configurable or variable size; a format based on the first preamble portion, the payload portion, and the second preamble portion; a format based on the payload portion; a format based on the payload portion, and cyclic redundancy check (CRC) bits; a format based on the CRC bits and the payload portion with a fixed size; a format defined based on the CRC bits and the payload portion with a configurable or variable size; a format based on waveforms; a format based on modulation schemes; a format based on presence of specific information; a format based on subcarrier spacing (SCS); a format based on repetition numbers for the signal or the preamble portion or payload portion; a format based on size (or length) of the payload portion or the signal; a format based on a number of user equipment (UEs) or wireless communication devices (e.g., to provide a coverage of a term for a UE); a format based on UE related information; or a format based on RRC states. If a UE ID is included/present, a related format can be defined. If a UE ID and a cell ID are defined, a related format can be defined.

In some embodiments, the signal may comprise one of a plurality of formats. The wireless communication device may determine the one of a plurality of formats to receive the signal according to at least one of: a radio resource control (RRC) state; a received signaling, or one or more resources on which the signal is transmitted. The RRC state may include RRC_CONNECTED state, RRC_INACTIVE state, or RRC_IDLE state.

In some embodiments, the wireless communication device may determine, according to a RRC_CONNECTED state, the one of the plurality of formats. The one of the plurality of formats may comprise at least one of: a plurality of preambles, a fixed data size, a configurable data size, cyclic redundancy check (CRC) bits, UE identifier (ID) related information, UE group ID related information, or physical downlink control channel (PDCCH) related information. For example, under an idle state, the information may include cell IDs, cell specific wake-up, or group UE IDs.

In some embodiments, the wireless communication device may receive the signal when the wireless communication device is in RRC_CONNECTED state. The wireless communication device may determine the behavior when the wireless communication device is in the RRC_CONNECTED state. The wireless communication device may receive the signal in RRC_CONNECTED state, under at least one of following situations: when a parameter is configured via radio resource control (RRC), media access control control element (MAC CE) or system information block (SIB) signaling; or when one or more bits or a field is present or indicated via downlink control information (DCI) signaling; when or before a specific timer has expired; after a specific time duration; after a specific physical downlink control channel (PDCCH) occasion or after a number of PDCCH occasions (e.g., predefined, signaled, or DCI indicated); within a time duration before DRX-on starting point; within a time duration before a physical downlink control channel (PDCCH) occasion; during a discontinuous reception off (DRX-off) period; during a wake up radio on (WUR-on) period; during a DRX on period; or according to a predefined condition. In some embodiments, the wireless communication device may always monitor after triggering DRX-on or DRX-off, except during PDCCH occasions. The predefined condition may include: once a LP-WUS is configured, the wireless communication device may keep detecting.

In some embodiments, when the wireless communication device is in RRC_CONNECTED state, the wireless communication device may not have to receive the signal under at least one of following situations: when a specific downlink (DL) signal or channel is received, or when a specific uplink (UL) signal or channel is transmitted; when a parameter is configured via radio resource control (RRC), media access control control element (MAC CE) or system information block (SIB) signaling; when one or more bits or a field is present or indicated in a downlink control information (DCI) signaling; when a DCI is received; when a physical downlink shared channel (PDSCH) is received; after a physical uplink control channel (PUCCH) is sent; based on a configuration for the wireless communication device; before or after a specific time duration; before or after a specific timer expires; or before or after a specific physical downlink control channel (PDCCH) occasion.

In some embodiments, when the wireless communication device is in RRC_CONNECTED state, the UE may not have to receive the signal under at least one of following situations: when a specific downlink (DL) signal or channel is received, or when a specific uplink (UL) signal or channel is transmitted; when a parameter is configured via radio resource control (RRC), media access control control element (MAC CE) or system information block (SIB) signaling; when one or more bits or a field is present or indicated in a downlink control information (DCI) signaling; when a DCI signaling is received; when a physical downlink shared channel (PDSCH) is received; after a physical uplink control channel (PUCCH) is sent; based on a configuration for the wireless communication device; before or after a specific time duration; before or after a specific timer expires; or before or after a specific physical downlink control channel (PDCCH) occasion.

In some embodiments, when the wireless communication device is in RRC_CONNECTED state, the UE may stop receiving the signal under at least one of following situations: when a specific downlink (DL) signal or channel is received, or when a specific uplink (UL) signal or channel is transmitted; when a parameter is configured via radio resource control (RRC), media access control control element (MAC CE) or system information block (SIB) signaling; when one or more bits or a field is present or indicated in a downlink control information (DCI) signaling; when a DCI signaling is received; when a physical downlink shared channel (PDSCH) is received; after a physical uplink control channel (PUCCH) is sent; based on a configuration for the wireless communication device; before or after a specific time duration; before or after a specific timer expires; or before or after a specific physical downlink control channel (PDCCH) occasion.

In some embodiments, the signal can be configured with at least one of: a repetition number; a periodicity; a time duration; resources no more than 1 slot and/or within 5 MHz or 20 MHz or 50 MHz; or frequency hopping. The signal may comprise/can be at least one of: a radio resource control (RRC) signaling, a system information block (SIB) signaling, a medium access control control element (MAC CE) signaling, or a downlink control information (DCI) signaling.

In some embodiments, the wireless communication device may determine the behavior according to the signal, the behavior comprising at least one of: sending, by the wireless communication device, a physical random access channel (PRACH) or a msgA; sending, by the wireless communication device, a physical uplink control channel (PUCCH); sending, by the wireless communication device, a physical uplink control channel (PUCCH) with HARQ-ACK; receiving, by the wireless communication device, the PDCCH; monitoring, by the wireless communication device, an PDCCH occasion; receiving, by the wireless communication device, a paging channel or transmission; monitoring, by the wireless communication device, a paging occasion; activating a DRX-on duration (e.g., next DRX-on duration); starting a timer; or activating measurement, detection, receiving or transmitting of a reference signal (RS).

In some embodiments, the wireless communication device may determine the behavior according to the signal, after or based on at least one of: a time period or duration; a number of PDCCH occasions; a specific PDCCH occasion; or expiration of a timer.

In some embodiments, the wireless communication node (e.g., a BS) may send a signal (e.g., a low power signal (WUS)) to a wireless communication device (e.g., a UE). The wireless communication device may determine a behavior according to the signal.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example power saving method, in accordance with some embodiments of the present disclosure;

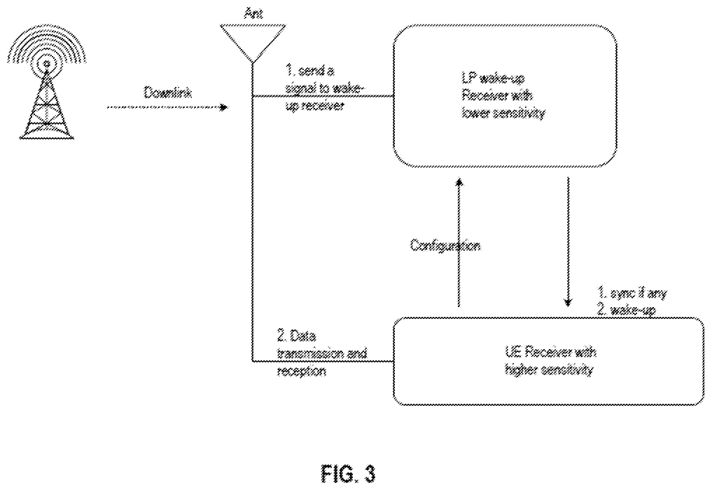

FIG. 4 illustrates an example format for low-power wake-up signal (LP-WUS), in accordance with some embodiments of the present disclosure; and

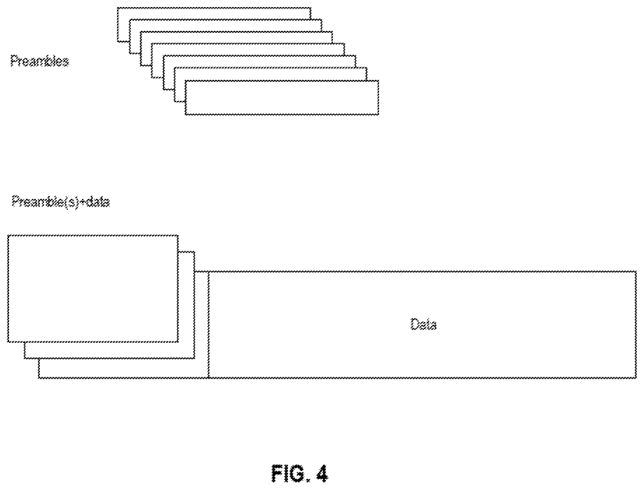

FIG. 5 illustrates a flow diagram for power saving in a communication system, in accordance with an embodiment of the present disclosure.

### DETAILED DESCRIPTION

### 1. Mobile Communication Technology and Environment

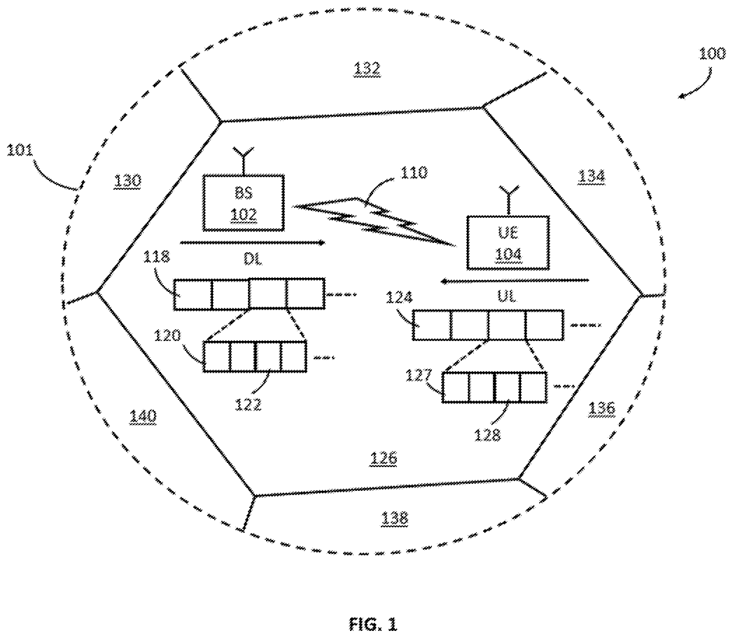

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

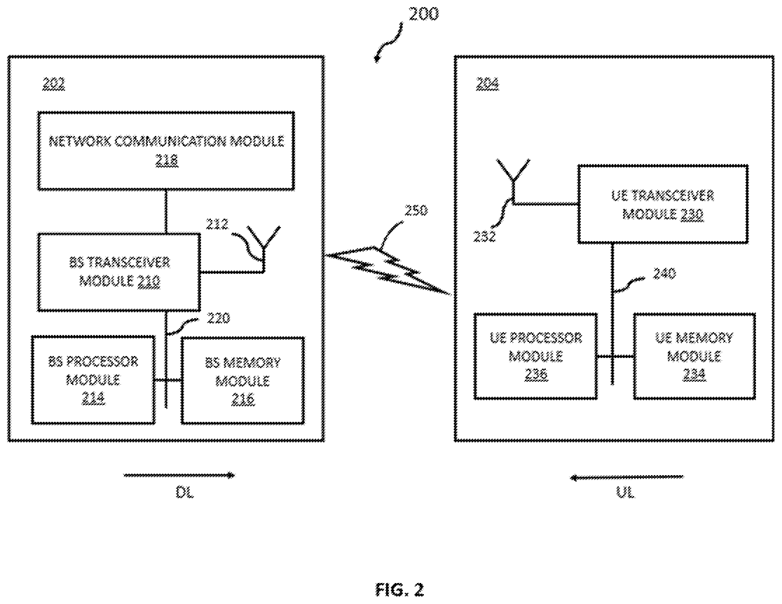

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Power Saving

A low-power wake-up signal (LP-WUS) can be used for power saving of a UE. However, in a connected mode or idle/inactive mode, how to design/use the LP-WUS is not clear. In this disclosure, how to enable/disable a LP-WUS detection, how to design a LP-WUS signal, and related behavior for LP-WUS are discussed. Therefore, a low-power wake-up signal (LP-WUS) in a wireless communication system can be performed.

A wireless communication deice (e.g., a UE) may receive a signal (e.g., a LP-WUS) from a wireless communication node (e.g., a BS). The wireless communication device may determine a behavior according to the signal. The signal can be modulated using on-off keying (OOK), frequency-shift keying (FSK), amplitude-shift keying (ASK), or orthogonal frequency division multiplexing (OFDM).

### Implementation Example 1: Information Carried by a LP-WUS

A signal (e.g., a LP-WUS) may carry at least one of following information: wake-up information; user equipment (UE) or wireless communication device identifier (ID) information; a defined ID information; UE or wireless communication device group information; a defined group ID information; cyclic redundancy check (CRC) information; radio network temporary identifier (RNTI) information; time duration or offset information; scrambling information; physical downlink control channel (PDCCH) related information; repetition information; frequency hopping information; discontinuous reception (DRX) related information; channel state information reference signal (CSI-RS) related information; tracking reference signal (TRS) availability information; search space (SS) group switching information; PDCCH skipping information; transmit power control (TPC) command information; sounding reference signal (SRS) request information; pre-emption indication information; channel occupancy time (COT) duration indicator information; available resource block (RB) set indicator information; secondary cell (SCell) dormancy indication information; or information based on any of foregoing information. It should be noted that the ID described in the present disclosure is not limited to an identifier, but can also be an identification, index, or number.

The wake-up information can be used to wake up a main radio or a UE by the WUR. The wake-up information can be used to determine a UE behavior. The wake-up information can be used to keep UE monitoring a channel or signal or an occasion (e.g., PDCCH occasion). The wake-up information can be used to start/end up a timer. The wake-up information may include timing information for the wake-up (e.g., a time length/offset/duration before the wake-up is to occur). For example, a time length may indicate a time length/offset/duration for a main radio (MR) or a UE wake-up to start detection of a physical downlink control channel (PDCCH). The wake-up information may indicate which PDCCH occasion to detect. In certain embodiments, the wireless communication device can be waked up after receiving the LP-WUS.

The user equipment (UE) or wireless communication device identifier (ID) information can be used to identify a specific UE/WUR to make sure that the signal is for a specific UE. The user equipment (UE) or wireless communication device identifier (ID) information can be a whole ID with more than 20 bits, e.g., 48 bits, or the UE or wireless communication device ID information can be a part of UE ID information, or the information based on UE ID (e.g., based on UE ID mod operation). For example, there can be N bits length UE ID. For example, x bits may indicate a number. The number can be obtained via the UE ID (e.g., the number can be obtained based on UE ID mod m and the number can be 0~m−1). For example, the number can be part of UE ID, odd-numbered UE ID, or even-numbered UE ID.

The defined ID information (e.g., WUR ID) can be configured by a gNB to the UE/WUR. The defined ID information can have less overhead compared with whole UE ID (e.g., less than 20 bits or 10 bits). In some embodiments, the ID information for a specific UE or WUR can be defined/configured by the gNB. For example, an M bits ID information configured by the gNB, where M can be 8 bits, 10 bit, 4 bits, 2 bits, 1 bit. In some embodiments, each UE configured with a parameter can be configured with the ID information.

The UE or wireless communication device group information can be obtained based on the user equipment (UE) or wireless communication device identifier (ID) information or defined ID information. The group information may comprise a group index. For example, X mod m=0~m−1. Each value of {X mod m} may correspond to a group of UEs. A LP-WUS resource for different groups of UEs may not overlap. A UE group index can be for a group of UEs. In some embodiments, there can be at least one index. In some embodiments, the UE group index can be obtained via modulus operation (e.g, UE ID mod B). B can be the number of groups.

A defined group ID information may comprise the ID for a group of UE which is configured by the gNB. The group ID may comprise a RNTI value. For example, X mod m=0~m−1. Each value of {X mod m} may correspond to a defined group of UEs. A LP-WUS resource for different groups of UEs may not overlap. In some embodiments, a group of UE′ ID information can be defined/configured by the gNB. In some embodiments, there can be at least one ID group index. In some embodiments, the defined ID group index can be obtained via modulus operation and/or defined ID information (e.g., defined ID mod B). B can be the number of groups.

A cyclic redundancy check (CRC) information can be attached with the payload portion. A cyclic redundancy check (CRC) information can be obtained based on UE identifier (ID) related information and/or UE group ID related information. The UE ID related information may comprise whole UE ID information, a part of UE ID information, or the information based on UE ID. The UE group ID related information may comprise whole UE group ID information, or the information based on UE group ID. In some embodiments, N bits CRC can be carried/attached. N can be 16, 24, some configured, or predefined. In some embodiments, the CRC bits can be determined based on the ID information (e.g., UE ID, defined ID, ID group, or defined ID group). In some embodiments, the CRC bits can be determined based on C-RNTI or defined RNTI with N bits.

The radio network temporary identifier (RNTI) information can be configured via the gNB (e.g., RRC). In some embodiments, N bits RNTI can be used to scramble the signal. In some embodiments, the RNTI can be specific for one UE (e.g., C-RNTI, defined RNTI for one UE). In some embodiments, the RNTI can be specific for multiple UEs or a group of UEs.

In some embodiments, the time duration or offset information can be for indicating the time duration or time offset between the signal and UE behavior. When the signal is received, after a time duration or time offset, the UE may determine the action. In some embodiments, the time duration/offset (us, us, slots, symbols, or based on a time unit) can be indicated via the signal. In some embodiments, a list of time duration/offset values can be configured via RRC parameters. In some embodiments, a duration/offset can be based on the PDCCH occasion (e.g., the first/second or other PDCCH occasion after receiving LP-WUS, e.g., skip a number of PDCCH occasions).

In some embodiments, the time duration or offset or period information can be for indicating the time duration or offset or period for UE behavior. For example, the UE may need to keep wake up during this time duration. For example, the UE can monitor PDCCH occasion in during this time duration. For example, the UE's DRX duration-on can be within this time duration. For example, UE's timer (e.g., timer for DRX-on) may expire within this duration.

The scrambling information can be used to scramble the signal for one UE, multiple UEs, or a group of UEs. The scrambling sequence can be based on UE ID(s), UE group ID.

In some embodiments, a group of UE can be multiple UEs, or all the UEs in a cell.

In some embodiments, physical downlink control channel (PDCCH) related information may comprise a predefined, signaled, or indicated PDCCH occasion. For example, the UE behavior may monitor on a PDCCH occasion. For example, physical downlink control channel (PDCCH) related information may indicate the next PDCCH occasion after a LP-WUS.

For example, physical downlink control channel (PDCCH) related information may indicate that a UE may monitor a specific PDCCH occasion.

In some embodiments, repetition information may indicate the repetition of payload portion or the repetition of a part of payload portion. Repetition information can be interpreted differently based on different condition. The repetition number may comprise at least one of {1, 2, 4, 8, 16, 32, 64, 128, 256, 512, 1024}.

In some embodiments, frequency hopping information may comprise a frequency hopping flag. Frequency hopping information may indicate whether frequency hopping is enabled. Frequency hopping information can be enabled only when repetition is supported/enabled/configured. The frequency hopping rule can be based on repetition, slot, symbols, or sequence.

In some embodiments, discontinuous reception (DRX) related information may comprise the DRX-on information, and/or DRX-off information. The DRX related information may indicate UE whether to behave during DRX-on duration or DRX-off duration. The DRX related information may indicate UE whether to start/end up DRX-on duration or DRX-off duration. The DRX related information may comprise any information based on DRX.

In some embodiments, channel state information reference signal (CSI-RS) related information may comprise the indication for related to CSI-RS. For example, the information may indicate the UE whether/how to receive CSI-RS, or may indicate whether/how report according to a CSI-RS.

In some embodiments, tracking reference signal (TRS) availability information may comprise the indication related to the TRS. For example, the information may indicate the UE whether/how to receive/monitor the TRS (occasion).

In some embodiments, search space (SS) group switching information may comprise the indication related to the SS group (set). For example, the information may indicate the UE whether/how to switch the SS group (set) for monitoring.

In some embodiments, PDCCH skipping information may comprise the indication related to PDCCH skipping information. For example, the information may indicate the UE whether/how to skip the PDCCH monitoring.

In some embodiments, transmit power control (TPC) command information may comprise the indication related to power. For example, the information may indicate the transmit power for signal itself. For example, the information may indicate the power for other channels or signals.

In some embodiments, sounding reference signal (SRS) request information may comprise the indication related to SRS. For example, the information may indicate the UE whether/how to send the SRS or SRS request.

In some embodiments, pre-emption indication information may comprise the indication related to resources pre-emption. For example, the information may indicate the gNB whether/how to pre-empty the resources. For example, the information may indicate the UE whether/how to detect the signal or other resources according to the information.

In some embodiments, channel occupancy time (COT) duration indicator information may comprise the information related to channel occupancy. For example, the information may indicate whether/how the UE performs/behaves according to the COT duration.

In some embodiment, available resource block (RB) set indicator information may comprise the information for available resource block (RB) set. For example, the information may indicate whether/how the UE performs/behaves according to available resource block (RB) set.

In some embodiments, secondary cell (SCell) dormancy indication information may comprise the information related to SCell. For example, the information may indicate the gNB whether/how to turn on the SCell. For example, the information may indicate the UE whether/how the UE performs/behaves according to the information.

In some embodiments, information based on any of foregoing information may comprise any combination of the first information, any part of first information, any information based on the first information.

For example, some combination of above information can be at least one of: ID information and wake-up indication; ID information and CRC or RNTI information; wake-up indication and CRC or RNTI information. For example, some combination of above information and other information can be: ID information or wake-up indication and some other predefined/configured bits. For example, the information based on above information can be: any one of above information and some other information.

In some embodiments, combination information can be joint indication. In some embodiments, ID information may include cell ID information.

### Implementation Example 2: Structures

A signal (e.g., low-power wake-up signal (LP-WUS)) may comprise at least one of: a preamble portion that comprises at least one preamble; a payload or data portion that comprises at least 1 bit; or the preamble portion and the payload or data portion. The LP-WUS may be used to specify that a signal is intended for wake-up of specific UEs.

If there is no preamble to send data in a signal, it may lead to relatively high error detection because the UE may not know when the data is transmitted. Therefore, a sequence or a preamble or some bits may be required to define a starting position for the data.

### (1) Preamble

In some embodiments, the signal (e.g., LP-WUS) in a connected mode may comprise preambles. The preambles can be configured by a gNB or predefined. In some embodiments, a LP-WUS in a connected mode may comprise preambles and data. In some embodiments, a LP-WUS in a connected mode may comprise preambles, data, and preambles. Preambles may include a predefined/configured sequence. The sequence can be used for determining a starting position of data portion in the signal and whether to receive/detect the signal. In such case, the preamble/sequence can be predetermined/predefined. In some embodiments, the sequence can be used for determining an end position of (data portion of) signal and where to stop receiving/detecting the signal. In such case, the preamble/sequence can be predetermined/predefined.

In some embodiments, preambles can be used for a connected mode. If preambles are used for different UEs, there can be at least one of the following conditions: a number of preambles can be no more than 128; a number of preambles can be no more than 64; a number of preambles can be no more than 16; a number of preambles can be configured by a gNB/high layer/system information blocks (SIB)/radio resource control (RRC), and a value may include {8,16, 64,128}; a length of preambles can be the same; a length of preambles can be different but no more than x (e.g., 4 kinds); a preamble can be associated with a WUR ID or UE ID, and different preamble can be associated with different UE ID/WUR ID; a preamble can be associated with a group of UEs, and different preamble can be associated with different UE group (ID); or different preamble may indicate different time length for wake-up.

In some embodiments, preambles can be transmitted in a time duration at least once. For example, the time duration can be based on us, ms, symbols, slots, or any other time units. In some embodiments, preambles can be transmitted with a periodicity. In some embodiments, preambles or the signal can be associated to a sync signal, a periodic signal.

If the preamble/sequence is used for determining the starting/ending position of LP-WUS, there can be at least one of the following conditions: a length of sequence can be configured by the gNB/high layer/SIB/RRC; a length of sequence can be predefined; or occupied symbols by the preamble/sequence can be no more than 3 symbols or 1 slot or N bits.

If two preambles/sequences are used for determining the starting and ending position of LP-WUS, there can be at least one of the following conditions: a length of sequence can be the same; two preambles can be the same; two preambles can be related or associated; or preambles/sequences can be predefined or configured. For example, one preamble can be a part of another preamble. For another example, two preambles can be complementary. For instance, the second preamble may repeat the first preamble.

### (2) Preamble+Fixed Data Size

In some embodiments, preambles and fixed data size can be used for a connected mode or an inactive mode. A data part may carry ID information, cyclic redundancy check (CRC) information, radio network temporary identifier (RNTI) information, or information based on any of foregoing information to identify a specific UE(s) or UE group. The length of data part can be predefined, gNB configured, or determined via the preamble.

In some embodiments, both the preamble and the data part may carry the ID information or ID based information. The ID based information may include part of ID information. By decoding both the preamble and the data part, the whole ID information or part of ID information can be decoded. ID information may comprise the user equipment (UE) or wireless communication device identifier (ID) information; a defined ID information; UE or wireless communication device group information; a defined group ID information; or cell ID.

The connected mode may correspond to a RRC_CONNECTED state. The inactive mode may correspond to a RRC_INACTIVE state. The idle mode may correspond to a RRC_IDLE state.

In some embodiments, preambles and configurable/variable data size can be used for an idle mode.

### (3) Preamble+Configurable/Variable Data Size

A preamble may indicate a length/size of data (e.g., different preamble may correspond to different data size). Predefined/configured (e.g., MSB) bits in data part may indicate the length/size of data. For example, 1, 2, 3, or x bits may indicate different size of data length. Predefined/configured bits in data part may explicitly or implicitly indicate the length of data in data part. Predefined/configured field/bits in the data portion of the WUS may indicate the carried information or fields for the carried information. The carried information may include an ID, ID based information, a system information (SI) notification, or a cell ID/tracking area/RAN area. For example, a field with bitmap to indicate whether fields for following information can be included: whether field for SI notification is included, whether field for TA information is included, or whether field for cell ID information is included. For example, several bits to indicate whether fields for these information can be included. The size of fields for carried information can be indicated via a gNB, high layer, SIB, RRC, medium access control control element (MAC CE), or downlink control information (DCI). The size for predefined/configured field/bits can be indicated via a gNB, high layer, SIB, RRC, medium access control control element (MAC CE), or downlink control information (DCI).

In some embodiments, the preamble portion may comprise or indicate at least one of the following: size of the payload portion; format of the payload portion or format of the signal; position of the payload portion; a time or frequency offset between the preamble portion and the payload portion; presence of specific information in the payload portion; presence of a specific indicator, bit or field in the payload portion; frequency hopping for the payload portion; repetition for the payload portion; cell identifier (ID) based information or UE related information. In some UE embodiments, UE related information may comprise the indication which is for one UE, a group of UEs, multiple UEs, or all the UEs in the Cell.

In some embodiments, a preamble and a data part may have the same center frequency. The preamble and the data part may have a frequency offset based on upper boundary, lower boundary, or center frequency. The data part may have a frequency offset based on preamble's upper boundary, lower boundary, or center frequency. The resources allocation for preamble or data part can be configured by gNB, high layer, SIB, RRC, medium access control control element (MAC CE), or downlink control information (DCI). The data part may have a time offset/gap/duration after preamble. The data part may have a time offset with the preamble. The UE can monitor/receive/detect the LP-WUS data part after preamble X slots/symbols/ms/us/time units, where X can be the time offset/gap/duration.

In some embodiments, there can be a frequency offset between the preamble portion and the payload portion; or there can be a time offset between the preamble portion and the payload portion. The time offset can also be a time duration, a gap based on us, ms, symbols, slots, or any other time units. The frequency offset can also be a frequency gap based on number of subcarriers and/or SCS.

### (4) Preamble+Variable Data Size+Preamble

A first preamble can be used for determining a start position of a LP-WUS. A second preamble can be used for determining an ending position of a LP-WUS. A predefined/configured relative position for each fields or information can be in data part. A predefined/configured size for each fields or information can be in data part. The data part may carry at least one of: wake-up information, UE ID information, group ID information, a system information modification, earthquake and tsunami warning system (ETWS), a cell ID/tracking area/RAN area, or a tracking reference signal (TRS) or first information. The first preamble and the second preamble may have the same frequency position, the same frequency resources, or the same frequency resources allocation. The first preamble and the second preamble may have a frequency offset (e.g., based on upper boundary, lower boundary, or center frequency). The first preamble, data part, and second preamble may have the same center frequency, the same frequency position, the same frequency resources, or the same frequency resources allocation.

In some embodiments, a frequency offset between a first preamble and a data part can be a first frequency offset. A frequency offset between a second preamble and a data part can be a second frequency offset. The first frequency offset can be the same with the second frequency offset, or different. The frequency offset can be configured by the gNB.

In some embodiments, a time offset/gap/duration between a first preamble and a data part can be a first time offset. A time offset/gap/duration between a second preamble and a data part can be a second time offset. The first time offset can be the same with second time offset, or different. The time offset can be configured by the gNB. In some embodiments, the first time offset and the second time offset can be predefined, or signaled to the wireless communication device, or indicated to the wireless communication device via a downlink control information (DCI) signaling.

### Implementation Example 3: Formats

(1) Based on the signal structure, following formats/types for a LP-WUS can be defined.

In some embodiments, a first format can be: preambles. The first format can be defined based on the preambles.

A second format can be: preamble+data. The second format can be defined based on the preambles and data.

In some embodiments, a first format can be: preambles. The first format can be defined based on the preambles.

A second format can be: preamble+fixed data size. The second format can be defined based on the preambles and fixed size data.

A third format can be: preamble+configurable/variable data size. The third format can be defined based on the preambles and variable size data.

A fourth format can be: preamble+data+preamble. The third format can be defined based on the preambles, variable size data, and preamble.

In some embodiments, the number of formats/types for LP-WUS can be no more than 4. The different formats/types may correspond to different signal structure. The different formats/types may have different data size. The different formats/types may have different parts, preamble, or data part. The different formats/types may have fixed or indictable/variable/configurable data size. The different formats/types may have different use cases (e.g., used in different RRC states).

TABLE 1

| | |
|---|---|
| Connected mode | The first format |
| Connected mode or inactive mode | The second format |
| Inactive mode or idle mode | The third format |

The different formats/types can be applied for one UE, a group of UE, different multiple UEs, or all the UEs in the cell. For example, the first format can be used for one UE. For example, the second format can be used for a group of UE. For example, the third format can be used for multiple specific UEs. Different signal formats may have different subcarrier spacing (SCS)/repetition. Different signal formats may have different definition on data length/size.

TABLE 2

| | |
|---|---|
| data length = 0 | The first format |
| Fixed data length | The second format |
| configurable/variable data length | The third format |

(2) Based on the preambles structure, following formats/types for a LP-WUS can be defined.

Different signal formats can be corresponding to different preambles (as shown in Table 3).

TABLE 3

| | |
|---|---|
| Preambles 1~x1 | The first format |
| Preambles x1 + 1~x2 | The second format |
| Preambles x2 + 1~128/64/32/16 | The third format |

Different signal formats are corresponding to different preamble length (as shown in Table 4).

TABLE 4

| | |
|---|---|
| Preambles length: short | The first format |
| Preambles length: long | The second format |

(3) Based on the preambles+data structure, following formats/types for LP-WUS can be defined.

Different signal formats can be corresponding to different data sizes/lengths. The different formats/types may have fixed or Indictable/variable/configurable data size. The different formats/types may have different use cases (e.g., used in different RRC states).

In some embodiments, a format can be based on multiple preambles; different preamble length has different formats. Different preamble for different information or usage may have different formats. For example, preamble for starting position or ending position, and preamble for UE related information may have different format.

In some embodiments, a format can be based on the presence of preamble portion, the presence of data portion, or frequency hopping, the presence of CRC bits, number of CRC bits, or the number of preamble portion, waveforms, SCS, modulation schemes, or specific information presence, or the presence of gap. The waveforms may comprise cyclic prefix orthogonal frequency-division multiplexing (CP-OFDM), direct Fourier transform spread (DFT-S) or OFDM. The modulation schemes may comprise on off keying (OOK), frequency shift keying (FSK), amplitude shift keying (ASK), or OFDM. The gap may comprise a time gap or a frequency gap.

In some embodiments, a format can be based on the UE number or different UE number range. For example, if the signal is for one UE, format 1 can be used. If the signal is for multiple UEs, format 2 can be used.

In some embodiments, a format can be based on specific information presence. For example, if UE ID information is included/present, a related format can be defined/used/configured/received. If UE ID and cell ID is defined, a related format can be defined/used/configured/received.

In some embodiments, a format can be based on RRC states wherein RRC states includes RRC_CONNECTED state, RRC_INACTIVE state, RRC_IDLE state. For example, different formats of signal can be defined for different RRC states.

In some embodiments, the signal may comprise one of a plurality of formats. The wireless communication device may determine the one of a plurality of formats to receive the signal according to at least one of: a radio resource control (RRC) state; a received signaling, or one or more resources on which the signal is transmitted.

In some embodiments, the wireless communication device may determine, according to a RRC_CONNECTED state, the one of the plurality of formats. The one of the plurality of formats may comprise at least one of: a plurality of preambles, a fixed data size, a configurable data size, cyclic redundancy check (CRC) bits, UE identifier (ID) related information, UE group ID related information, or physical downlink control channel (PDCCH) related information.

In some embodiments, the wireless communication device may determine the one of a plurality of formats to receive the signal, comprising at least one of: the UE receives the format with a configurable/variable data size in idle mode, and receives a format with fixed data size in connected mode; the UE receives the format with a long preamble length in idle mode, and receives a format with a shorter preamble length in connected mode; the UE receives the format with a larger size payload in idle mode, and receives a smaller size payload in connected mode; the UE receives the format with a larger gap between preamble and payload portion in idle mode and the UE receives the format with a smaller gap between preamble and payload portion in connected mode; the UE receives the format with preamble portion presence in idle mode, and receives the format with preamble portion absence in connected mode; the UE receives the format with preamble portion absence in idle mode, and receives the format with preamble portion presence in connected mode; the UE receives the format with specific information presence in idle mode, and receives the format with specific information absence in connected mode. The specific information can be cell ID or any one in first information.

### Implementation Example 4: Activation/Deactivation

In some embodiments, the wireless communication device may receive the signal when the wireless communication device is in RRC_CONNECTED state. The wireless communication device may determine the behavior when the wireless communication device is in RRC_CONNECTED state.

In some embodiments, the wireless communication device may receive the signal in RRC_CONNECTED state, under at least one of following situations: when a parameter is configured via radio resource control (RRC), media access control control element (MAC CE) or system information block (SIB) signaling; or when one or more bits or a field is present or indicated via downlink control information (DCI) signaling; when or before a specific timer has expired; after a specific time duration; after a specific physical downlink control channel (PDCCH) occasion or after a number of PDCCH occasions (e.g., predefined, signaled, or DCI indicated); within a time duration before DRX-on starting point; within a time duration before a physical downlink control channel (PDCCH) occasion; during a discontinuous reception off (DRX-off) period; during a wake up radio on (WUR-on) period; during a DRX on period; or according to a predefined condition.

In some embodiments, the wireless communication device may receive the signal in RRC_CONNECTED state when or before a specific timer has expired. For example, when the DRX duration-on timer expires, the UE may receive the signal. For example, before the DRX duration-on timer expires, the UE may receive the signal. For example, when or before a defined timer expires, the UE may receive the signal.

In some embodiments, the wireless communication device may receive the signal in RRC_CONNECTED state after a specific time duration. For example, after UE receive the signal a time duration, the UE may receive the signal again. For example, after a specific PDCCH a time duration, the UE may receive the signal. For example, after a PUCCH a time duration, the UE may receive the signal. For example, after a specific signal/channel a time duration, the UE may receive the signal. For example, after a signalling via the gNB a time duration, the UE may receive the signal.

In some embodiments, the wireless communication device may receive the signal in RRC_CONNECTED state before DRX-on starting point. In some embodiments, the wireless communication device may receive the signal in RRC_CONNECTED state within a time duration before DRX-on starting point. In some embodiments, the wireless communication device may receive the signal in RRC_CONNECTED state during a wake up radio on (WUR-on) period. The WUR-on period can be viewed as kind of time window. And/or the WUR-on periodic can be configured with an offset or a periodicity. In some embodiments, the wireless communication device may receive the signal in RRC_CONNECTED state according to a predefined condition. For example, the condition can be based on measurement results, RSRP, RSSI, or RSRQ. In some embodiments, “receive” may also mean detect or monitor.

In some embodiments, when the wireless communication device is in RRC_CONNECTED state, the wireless communication device may not have to receive the signal under at least one of following situations. After the wireless communication device receives the signal in RRC_CONNECTED state, the wireless communication device may stop receiving the signal under at least one of following situations: when a specific downlink (DL) signal or channel is received, or when a specific uplink (UL) signal or channel is transmitted; when a parameter is configured via radio resource control (RRC), media access control control element (MAC CE) or system information block (SIB) signaling; when one or more bits or a field is present or indicated in a downlink control information (DCI) signaling; when a DCI is received; when a physical downlink shared channel (PDSCH) is received; after a physical uplink control channel (PUCCH) is sent; based on a configuration for the wireless communication device; before or after a specific time duration; before or after a specific timer expires; or before or after a specific physical downlink control channel (PDCCH) occasion.

In some embodiments, the UE may stop receiving or may not have to receive the signal, when a specific downlink (DL) signal or channel is received, or when a specific uplink (UL) signal or channel is transmitted. For example, the DL channel can be PDSCH, or the UL channel can be PUCCH.

In some embodiments, the UE may stop receiving or may not have to receive the signal, when a DCI signaling is received. For example, the DCI can be a C-RNTI scrambled DCI. The DCI can be a DCI received in a specific PDCCH occasion. The DCI can be the first DCI received during DRX-on duration.

In some embodiments, the UE may stop receiving or may not have to receive the signal, before or after a specific time duration. For example, the specific time duration can be after a PDCCH occasion, a DL signal/channel or the LP-WUS signal. For example, the specific time duration can be before a PDCCH occasion, a UL signal/channel, DRX-on duration. For example, the UE may stop receiving the signal after the ending of DRX-on a time duration. For example, the UE may stop receiving the signal after the starting of DRX-off in a time duration. For example, the UE may not have to receive the signal after a received PDCCH in a time duration. For example, the UE may not have to receive the signal after a time duration defined for WUR-on period.

In some embodiments, the UE may stop receiving or may not have to receive the signal before or after a specific timer expires; for example, the timer can be related to drx-onDurationTimer, drx-InactivityTimer, bwp-InactivityTimer.

In some embodiments, the UE may stop receiving or may not have to receive the signal before or after a specific physical downlink control channel (PDCCH) occasion. For example, before the first PDCCH occasion during DRX-on period, the UE may stop receiving or may not have to receive the signal. For example, before the last PDCCH occasion during DRX-on period, the UE may stop receiving or does not have to receive the signal.

In some embodiments, the signal (e.g., LP-WUS) can be the signal which is configured with at least one of: a repetition number; a periodicity; a time duration; resources no more than 1 slot and/or within 5 MHz or 20 MHz or 50 MHz; or frequency hopping. For example, the repetition number can be at least one of {1, 2, 4, 8, 16, 32, 64, 128, 256, 512, 1024}. For example, the periodicity can be at least one of {10, 20, 40, 80, 160, 320, 640, 1280, 2560} ms/us/slots or any other time units. For example, the time duration can be {10, 20, 40, 80, 160, 320, 640, 1280, 2560} ms/us/slots or any other time units. For example, frequency hopping can a frequency hopping flag.

In some embodiments, the wireless communication device may determine the behavior according to the signal. The behavior may comprise at least one of: sending, by the wireless communication device, a physical random access channel (PRACH) or a msgA; sending, by the wireless communication device, a physical uplink control channel (PUCCH); sending, by the wireless communication device, a physical uplink control channel (PUCCH) with HARQ-ACK; receiving, by the wireless communication device, the PDCCH; monitoring, by the wireless communication device, an PDCCH occasion; receiving, by the wireless communication device, a paging channel or transmission; monitoring, by the wireless communication device, a paging occasion; activating a DRX-on duration; starting a timer; or activating measurement, detection, receiving or transmitting of a reference signal (RS).

In some embodiments, the behavior may comprise activating measurement, detection, receiving or transmitting of a reference signal (RS). For example, the UE may need to perform measurement after receiving the LP-WUS signal. For example, UE may trigger the SRS/PUCCH transmission after receiving the LP-WUS signal. For example, UE may report the CSI after receiving the LP-WUS signal. For example, UE may receive the TRA, CSI-RS, SSB, PSS, or SSS after receiving the signal.

In some embodiments, the behavior may comprise sending, by the wireless communication device, a physical random access channel (PRACH) or a msgA. For example, the PRACH resource can be configured by high layer and can be specific for LP-WUS function. For example, PRACH occasion for sending PRACH after the signal (e.g., LP-WUS) can be based on UE ID or ID information or UE related information. For example, msg2 or msg3 after PRACH carries the UE ID or ID information or UE related information indicating the corresponding UE may not be paged by the network.

In some embodiments, the wireless communication device may determine the behavior according to the signal, after or based on at least one of: a time period or duration; a number of PDCCH occasions; a specific PDCCH occasion; or expiration of a timer. For example, the UE behavior can be after a time duration. For example, the UE behavior can during a time duration. For example, the UE behavior can be after a specific PDCCH occasion. For example, the UE behavior can be based on a PDCCH occasion, including paging occasion, RACH occasion and other PDCCH occasion. For example, the UE behavior can be after/based on expiration of a timer. For example, the timer can be related to DRX or BWP switching.

In some embodiments, the LP-WUS can be an example of the signal. It can be replaced as signal.

### Activation

A second node (e.g., a UE or a WUR) may receive a LP-WUS in a connected mode with following configurations or conditions. The UE can be configured with a parameter by RRC/SIB/high later/MAC signaling for enabling or activating LP-WUS. The UE may receive a DCI, indicating that keeping monitoring LP-WUS (e.g., 1 bit in a field to indicate). A timer expires (e.g., drx-onDurationTimer, drx-InactivityTimer, bwp-InactivityTimer).

In some embodiment, the second node (e.g., a UE or a WUR) may receive a LP-WUS in inactive/idle mode with following configurations or conditions. The UE can be configured with the parameter by SIB/high layer/MAC signaling for enabling or activating LP-WUS. The DCI with format 1-0 may indicate enabling or activating LP-WUS.

### Deactivation

A second node (e.g., a UE or a WUR) may not receive/monitor a LP-WUS in a connected mode with following configurations or conditions.

After receiving a LP-WUS, the second node may not keep monitoring/detecting the LP-WUS. For non-discontinuous reception (DRX) operation mode, in connected mode, the UE may keep wake-up. If a LP-WUS only works in the first time wake-up, there may be not much power saving benefits. Therefore, the second node may continue to sleep after the base station sends the data. After receiving the LP-WUS, the monitoring of the LP-WUS can be temporarily turned off, and may wait for an instruction to notify the second node that the data transmission is over. The second node can continue to sleep, and the second node may continue to monitor the LP-WUS. For DRX operation mode, in addition to newly defined instructions, the second node may rely on DRX to turn off and turn on to monitor LP-WUS.

After receiving a LP-WUS, the second node may keep monitoring/detecting the LP-WUS. The second node may monitor other signaling (not wake-up signaling). The other signaling may include, for example, disabling LP-WUS monitoring and disabling LP-WUS functions. Both can be completed by DCI or high-level signaling. However, there can be no strong motivation to continue monitoring after receiving LP-WUS.

A more reasonable way can be that after the second node receives LP-WUS wake-up in the connected state, the second node may not continue to detect LP-WUS until there is a signaling instruction to continue to enable LP-WUS detection. At the time, it may mean/indicate that the data has been transmitted at certain stage. In some embodiments, the UE can wake-up after receiving the LP-WUS. The UE may receive a DL grant/DCI. The UE may receive the deactivation signaling via a RRC/SIB/high later/MAC signaling.

### Implementation Example 5: Some Other Considerations

A repetition number for a LP-WUS transmission in connected mode can be configured by a RRC/SIB/high layer parameter/MAC CE.

A number of symbols occupied by LP-WUS can be a multiple of 7 or 14. In such way, multiple repetitions can be guaranteed to make the resource department as fragmented as possible.

For an idle state, the UE may initiate a physical random access channel (PRACHO to check that the LP-WUS has been effectively awakened. In a connected state, the UE may determine whether continues to initiate PRACH. In the idle state, the LP-WUS may indicate whether the PRACH can be allocated separately. If the base station does not wake up, the LP-WUS can be indicated in the DCI of msg 2 or msg 3. In some embodiments, random access initiated by LP-WUS may use a separate PRACH resource.

After the UE receives the LP-WUS, the UE may send a signal/channel to the gNB within a time duration or with a delay. The signal/channel may comprise a dedicated PRACH and/or a PUCCH. The dedicated PRACH can be configured by the high layer parameters/RRC. A configured/predefined PUCCH or some bits in PUCCH may indicate that it is a LP-WUS feedback. A time duration or delay can be configured by high layers/RRC parameters/SIB.

After the UE receives the LP-WUS, the UE may send a signal/channel to the gNB within a time duration or with a delay in a connected mode.

If the UE does not receive the DCI/grant in a time period after the UE sends the PUCCH or PRACH for LP-WUS, the UE may wake-up.

If the UE does not receive the DCI/grant in a next 1~x PDCCH occasion(s) after the UE sends the PUCCH or PRACH for LP-WUS, the UE may wake-up.

It should be understood that one or more features from the above implementation examples are not exclusive to the specific implementation examples, but can be combined in any manner (e.g., in any priority and/or order, concurrently or otherwise).

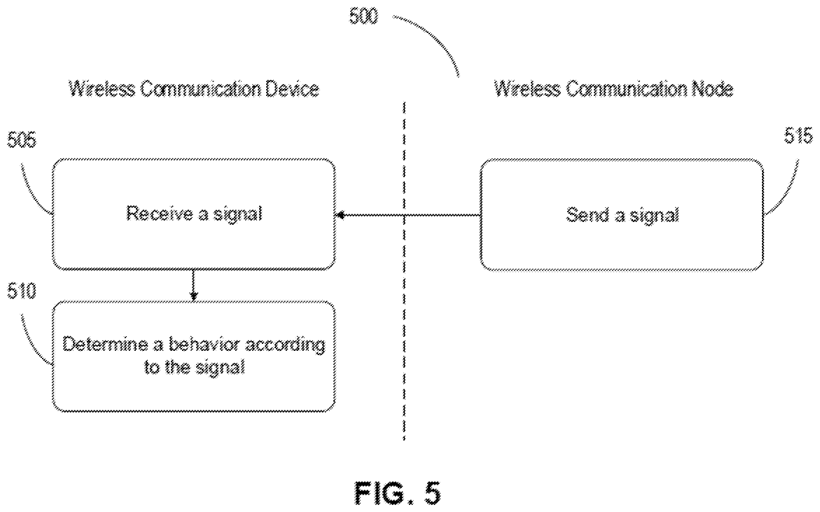

FIG. 5 illustrates a flow diagram for power saving, in accordance with an embodiment of the present disclosure. The method 500 may be implemented using any one or more of the components and devices detailed herein in conjunction with FIGS. 1-2. In overview, the method 500 may be performed by a wireless communication device, in some embodiments. Additional, fewer, or different operations may be performed in the method 500 depending on the embodiment. At least one aspect of the operations is directed to a system, method, apparatus, or a computer-readable medium.

A wireless communication device (e.g., a UE) may receive a signal (e.g., a low power signal, a wake up signal (WUS), a low power wake up signal) from a wireless communication node (e.g., a BS). The wireless communication device may determine a behavior according to the signal. The signal may comprise first information. The first information may comprise at least one of: wake-up information; user equipment (UE) or wireless communication device identifier (ID) information; a defined ID information; UE or wireless communication device group information; a defined group ID information; cyclic redundancy check (CRC) information; radio network temporary identifier (RNTI) information; time duration or offset information; scrambling information; physical downlink control channel (PDCCH) related information; repetition information; frequency hopping information; discontinuous reception (DRX) related information; channel state information reference signal (CSI-RS) related information; tracking reference signal (TRS) availability information; search space (SS) group switching information; PDCCH skipping information; transmit power control (TPC) command information; sounding reference signal (SRS) request information; pre-emption indication information; channel occupancy time (COT) duration indicator information; available resource block (RB) set indicator information; secondary cell (SCell) dormancy indication information; or information based on any of foregoing information.

In some embodiments, a low-power wake-up signal (LP-WUS) may trigger a UE action for power saving instead of always-on monitoring. The wake-up information can be timing information for the wake-up (e.g., time length/offset/duration before the wake-up is to occur). A physical downlink control channel (PDCCH) information may comprise a predefined, signaled, or indicated PDCCH occasion. The information based on any of foregoing information comprise at least one of: information combination of the first information, a UE ID based information, or part of UE ID information. A time duration/offset information may comprise at least one of: a time duration/offset between the signal and a PDCCH occasion; a time duration/offset between the signal and a PRACH occasion; or a time duration/offset between the signal and a paging occasion.

In some embodiments, the signal may comprise at least one of: a preamble portion; or a payload portion. The preamble portion may comprise at least one preamble. The payload portion may comprise at least 1 bit. The preamble portion and the payload portion may comprise: the preamble portion, followed by an offset, and followed by the payload portion. The offset can be a time duration/gap (e.g., 0, 10, or 20) based on subcarriers, time units, symbols, slots, us, or ms. The offset may comprise: a frequency offset between the preamble portion and the payload portion; or a time offset between the preamble portion and the payload portion. The payload may include a cyclic redundancy check (CRC), or not include CRC. The payload portion and a data portion can be similar. The preamble portion and the payload portion may comprise: a first preamble portion, followed by the payload portion, and followed by a second preamble portion.

In some embodiments, the first preamble portion, the payload portion and the second preamble portion can be continuous in time domain. A first time offset (e.g., a gap, a duration, a period, or an interval) between the first preamble portion and the payload portion, can be same as a second time offset between the second preamble portion and the payload portion. The first time offset and the second time offset can be predefined, or signaled to the wireless communication device, or indicated to the wireless communication device via downlink control information (DCI) signaling. The preamble portion may comprise or indicate at least one of: the first information, or information based on the first information; size of the payload portion; format of the payload portion or format of the signal; position (e.g., starting position or ending position) of the payload portion; a time or frequency offset between the preamble portion and the payload portion; presence of specific information in the payload portion; presence of a specific indicator, bit or field in the payload portion; frequency hopping for the payload portion; repetition for the payload portion; cell identifier (ID) based information (e.g., part of cell ID, whole cell ID, tracking area, or RAN area); or UE related information.

In some embodiments, the preamble portion and the payload portion can be continuous in time domain or frequency domain. The frequency offset or the time offset can be predefined, or signaled to the wireless communication device, or indicated to the wireless communication device via downlink control information (DCI) signaling. The signaling may include a radio resource control (RRC) signaling, a medium access control control element (MAC CE) signaling, or a system information block (SIB) signaling. In some embodiments, a UE may inspect/detect the preamble portion through a blind detection of candidate signal.

In some embodiments, the signal may include one of a plurality of formats. The plurality of formats may comprise at least one of: a format based on multiple preambles; a format based on the preamble portion; a format based on the preamble portion, and the payload portion; a format based on the preamble portion, and the payload portion with a fixed size; a format based on the preamble portion, and the payload portion with a configurable or variable size; a format based on the first preamble portion, the payload portion, and the second preamble portion; a format based on the payload portion; a format based on the payload portion, and cyclic redundancy check (CRC) bits; a format based on the CRC bits and the payload portion with a fixed size; a format defined based on the CRC bits and the payload portion with a configurable or variable size; a format based on waveforms; a format based on modulation schemes; a format based on presence of specific information; a format based on subcarrier spacing (SCS); a format based on repetition numbers for the signal or the preamble portion or payload portion; a format based on size (or length) of the payload portion or the signal; a format based on a number of user equipment (UEs) or wireless communication devices (e.g., to provide a coverage of a term for a UE); a format based on UE related information; or a format based on RRC states. If a UE ID is included/present, a related format can be defined. If a UE ID and a cell ID are defined, a related format can be defined.

In some embodiments, the signal may comprise one of a plurality of formats. The wireless communication device may determine the one of a plurality of formats to receive the signal according to at least one of: a radio resource control (RRC) state; a received signaling, or one or more resources on which the signal is transmitted. The RRC state may include RRC_CONNECTED state, RRC_INACTIVE state, or RRC_IDLE state.

In some embodiments, the wireless communication device may determine, according to a RRC_CONNECTED state, the one of the plurality of formats. The one of the plurality of formats may comprise at least one of: a plurality of preambles, a fixed data size, a configurable data size, cyclic redundancy check (CRC) bits, UE identifier (ID) related information, UE group ID related information, or physical downlink control channel (PDCCH) related information. For example, under an idle state, the information may include cell IDs, cell specific wake-up, or group UE IDs.

In some embodiments, the wireless communication device may receive the signal when the wireless communication device is in RRC_CONNECTED state. The wireless communication device may determine the action when the wireless communication device is in the RRC_CONNECTED state. The wireless communication device may receive the signal in RRC_CONNECTED state, under at least one of following situations: when a parameter is configured via radio resource control (RRC), media access control control element (MAC CE) or system information block (SIB) signaling; or when one or more bits or a field is present or indicated via downlink control information (DCI) signaling; when or before a specific timer has expired; after a specific time duration; after a specific physical downlink control channel (PDCCH) occasion or after a number of PDCCH occasions (e.g., predefined, signaled, or DCI indicated); within a time duration before DRX-on starting point; within a time duration before a physical downlink control channel (PDCCH) occasion; during a discontinuous reception off (DRX-off) period; during a wake up radio on (WUR-on) period; during a DRX on period; or according to a predefined condition. In some embodiments, the wireless communication device may always monitor after triggering DRX-on or DRX-off, except during PDCCH occasions. The predefined condition may include: once a LP-WUS is configured, the wireless communication device may keep detecting.

In some embodiments, when the wireless communication device is in RRC_CONNECTED state, the wireless communication device may not have to receive the signal under at least one of following situations: when a specific downlink (DL) signal or channel is received, or when a specific uplink (UL) signal or channel is transmitted; when a parameter is configured via radio resource control (RRC), media access control control element (MAC CE) or system information block (SIB) signaling; when one or more bits or a field is present or indicated in a downlink control information (DCI) signaling; when a DCI is received; when a physical downlink shared channel (PDSCH) is received; after a physical uplink control channel (PUCCH) is sent; based on a configuration for the wireless communication device; before or after a specific time duration; before or after a specific timer expires; or before or after a specific physical downlink control channel (PDCCH) occasion.

In some embodiments, when the wireless communication device is in RRC_CONNECTED state, the UE may not have to receive the signal under at least one of following situations: when a specific downlink (DL) signal or channel is received, or when a specific uplink (UL) signal or channel is transmitted; when a parameter is configured via radio resource control (RRC), media access control control element (MAC CE) or system information block (SIB) signaling; when one or more bits or a field is present or indicated in a downlink control information (DCI) signaling; when a DCI signaling is received; when a physical downlink shared channel (PDSCH) is received; after a physical uplink control channel (PUCCH) is sent; based on a configuration for the wireless communication device; before or after a specific time duration; before or after a specific timer expires; or before or after a specific physical downlink control channel (PDCCH) occasion.

In some embodiments, when the wireless communication device is in RRC_CONNECTED state, the UE may stop receiving the signal under at least one of following situations: when a specific downlink (DL) signal or channel is received, or when a specific uplink (UL) signal or channel is transmitted; when a parameter is configured via radio resource control (RRC), media access control control element (MAC CE) or system information block (SIB) signaling; when one or more bits or a field is present or indicated in a downlink control information (DCI) signaling; when a DCI signaling is received; when a physical downlink shared channel (PDSCH) is received; after a physical uplink control channel (PUCCH) is sent; based on a configuration for the wireless communication device; before or after a specific time duration; before or after a specific timer expires; or before or after a specific physical downlink control channel (PDCCH) occasion.

In some embodiments, the signal can be configured with at least one of: a repetition number; a periodicity; a time duration; resources no more than 1 slot and/or within 5 MHz or 20 MHz or 50 MHz; or frequency hopping. The signal may comprise/can be at least one of: a radio resource control (RRC) signaling, a system information block (SIB) signaling, a medium access control control element (MAC CE) signaling, or a downlink control information (DCI) signaling.

In some embodiments, the wireless communication device may determine the behavior according to the signal, the behavior comprising at least one of: sending, by the wireless communication device, a physical random access channel (PRACH) or a msgA; sending, by the wireless communication device, a physical uplink control channel (PUCCH); sending, by the wireless communication device, a physical uplink control channel (PUCCH) with HARQ-ACK; receiving, by the wireless communication device, the PDCCH; monitoring, by the wireless communication device, an PDCCH occasion; receiving, by the wireless communication device, a paging channel or transmission; monitoring, by the wireless communication device, a paging occasion; activating a DRX-on duration (e.g., next DRX-on duration); starting a timer; or activating measurement, detection, receiving or transmitting of a reference signal (RS).

In some embodiments, the wireless communication device may determine the behavior according to the signal, after or based on at least one of: a time period or duration; a number of PDCCH occasions; a specific PDCCH occasion; or expiration of a timer.

In some embodiments, the wireless communication node (e.g., a BS) may send a signal (e.g., a low power signal (WUS)) to a wireless communication device (e.g., a UE). The wireless communication device may determine a behavior according to the signal.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a signal; and
determining, by the wireless communication device, a behavior according to the signal.

2. The method of claim 1, wherein the signal comprises first information, the first information comprising at least one of:
wake-up information;
user equipment (UE) or wireless communication device identifier (ID) information;\ a defined ID information;
UE or wireless communication device group information;
a defined group ID information;
cyclic redundancy check (CRC) information;
radio network temporary identifier (RNTI) information;
time duration or offset information;
scrambling information;
physical downlink control channel (PDCCH) related information;
repetition information;
frequency hopping information;
discontinuous reception (DRX) related information;
channel state information reference signal (CSI-RS) related information;
tracking reference signal (TRS) availability information;
search space (SS) group switching information;
PDCCH skipping information;
transmit power control (TPC) command information;
sounding reference signal (SRS) request information;
pre-emption indication information;
channel occupancy time (COT) duration indicator information;
available resource block (RB) set indicator information;
secondary cell (SCell) dormancy indication information; or
information based on any of foregoing information.

3. The method of claim 2, wherein the signal comprises at least one of:
a preamble portion; or
a payload portion.

4. The method of claim 3, wherein the preamble portion and the payload portion comprise:
the preamble portion, followed by an offset, and followed by the payload portion.

5. The method of claim 4, wherein the offset comprises:
a frequency offset between the preamble portion and the payload portion; or
a time offset between the preamble portion and the payload portion.

6. The method of claim 3, wherein the preamble portion and the payload portion comprise:
a first preamble portion, followed by the payload portion, and followed by a second preamble portion.

7. The method of claim 6, wherein:
the first preamble portion, the payload portion and the second preamble portion are continuous in time domain; or
a first time offset between the first preamble portion and the payload portion, is same as a second time offset between the second preamble portion and the payload portion; or
the first time offset and the second time offset are predefined, or signaled to the wireless communication device, or indicated to the wireless communication device via downlink control information (DCI) signaling.

8. The method of claim 3, wherein the preamble portion comprises or indicates at least one of:
the first information, or information based on the first information;
size of the payload portion;
format of the payload portion or format of the signal;
position of the payload portion;
a time or frequency offset between the preamble portion and the payload portion;
presence of specific information in the payload portion;
presence of a specific indicator, bit or field in the payload portion;
frequency hopping for the payload portion;
repetition for the payload portion;
cell identifier (ID) based information; or
UE related information.

9. The method of claim 1, wherein the signal includes one of a plurality of formats, the plurality of formats comprising at least one of:
a format based on multiple preambles;
a format based on the preamble portion;
a format based on the preamble portion, and the payload portion;
a format based on the preamble portion, and the payload portion with a fixed size;
a format based on the preamble portion, and the payload portion with a configurable or variable size;
a format based on the first preamble portion, the payload portion, and the second preamble portion;
a format based on the payload portion;
a format based on the payload portion, and cyclic redundancy check (CRC) bits;
a format based on the CRC bits and the payload portion with a fixed size;
a format defined based on the CRC bits and the payload portion with a configurable or variable size;
a format based on waveforms;
a format based on modulation schemes;
a format based on presence of specific information;
a format based on subcarrier spacing (SCS);
a format based on repetition numbers for the signal or the preamble portion or payload portion;
a format based on size of the payload portion or the signal;
a format based on a number of user equipment (UEs) or wireless communication devices;
a format based on UE related information; or
a format based on RRC states.

10. The method of claim 1, wherein the signal comprises one of a plurality of formats, and the wireless communication device determines the one of a plurality of formats to receive the signal according to at least one of:
a radio resource control (RRC) state;
a received signaling, or
one or more resources on which the signal is transmitted.

11. The method of claim 10, wherein the wireless communication device determines, according to a RRC_CONNECTED state, the one of the plurality of formats, wherein the one of the plurality of formats comprises at least one of:
a plurality of preambles,
a fixed data size,
a configurable data size,
cyclic redundancy check (CRC) bits,
UE identifier (ID) related information,
UE group ID related information, or
physical downlink control channel (PDCCH) related information.

12. The method of claim 1, comprising:
receiving, by the wireless communication device, the signal when the wireless communication device is in RRC_CONNECTED state; or
determining, by the wireless communication device, the action when the wireless communication device is in the RRC_CONNECTED state.

13. The method of claim 12, wherein;
the wireless communication device receives the signal in RRC_CONNECTED state, under at least one of following situations:
when a parameter is configured via radio resource control (RRC), media access control control element (MAC CE) or system information block (SIB) signaling;
when one or more bits or a field is present or indicated via downlink control information (DCI) signaling;
when or before a specific timer has expired;
after a specific time duration;
after a specific physical downlink control channel (PDCCH) occasion or after a number of PDCCH occasions;
within a time duration before DRX-on starting point;
within a time duration before a physical downlink control channel (PDCCH) occasion;
during a wake up radio on (WUR-on) period;
during a discontinuous reception off (DRX-off) period;
during a DRX on period; or
according to a predefined condition; or
when the wireless communication device is in RRC_CONNECTED state, the wireless communication device does not have to receive the signal under at least one of following situations:
when a specific downlink (DL) signal or channel is received, or when a specific uplink (UL) signal or channel is transmitted;
when a parameter is configured via radio resource control (RRC), media access control control element (MAC CE) or system information block (SIB) signaling;
when one or more bits or a field is present or indicated in a downlink control information (DCI) signaling;
when a DCI is received;
when a physical downlink shared channel (PDSCH) is received;
after a physical uplink control channel (PUCCH) is sent;
based on a configuration for the wireless communication device;
before or after a specific time duration;
before or after a specific timer expires; or
before or after a specific physical downlink control channel (PDCCH) occasion.

14. (canceled)

15. The method of claim 1, wherein the signal is configured with at least one of:
a repetition number;
a periodicity;
a time duration;
resources no more than 1 slot and/or within 5 MHz or 20 MHz or 50 MHz; or
frequency hopping.

16. The method of claim 1, comprising:
determining, by the wireless communication device, the behavior according to the signal, the behavior comprising at least one of:
sending, by the wireless communication device, a physical random access channel (PRACH) or a msgA;
sending, by the wireless communication device, a physical uplink control channel (PUCCH);
sending, by the wireless communication device, a physical uplink control channel (PUCCH) with HARQ-ACK;
receiving, by the wireless communication device, the PDCCH;
monitoring, by the wireless communication device, an PDCCH occasion;
receiving, by the wireless communication device, a paging channel or transmission;
monitoring, by the wireless communication device, a paging occasion;
activating a DRX-on duration;
starting a timer; or
activating measurement, detection, receiving or transmitting of a reference signal (RS); or
determining, by the wireless communication device, the behavior according to the signal, after or based on at least one of:
a time period or duration;
a number of PDCCH occasions;
a specific PDCCH occasion; or
expiration of a timer.

17. (canceled)

18. A method comprising:
sending, by a wireless communication node to a wireless communication device, a signal,
wherein the wireless communication device determines a behavior according to the signal.

19. A non-transitory computer readable medium storing instructions, which when executed by at least one processor, cause the at least one processor to perform the method of claim 1.

20. An apparatus comprising:
at least one processor configured to perform the method of claim 1.

21. A non-transitory computer readable medium storing instructions, which when executed by at least one processor, cause the at least one processor to perform the method of claim 18.

22. An apparatus comprising:
at least one processor configured to perform the method of claim 18.
